(19) United States
(12) Patent Application Publication
(10) Pub. No.: US 2024/0032725 A1
(43) Pub. Date: Feb. 1, 2024

(54) Cartridge Receptacle, Cartridge System, Beverage Preparation System and Method for Preparing a Beverage

(71) Applicant: Freezio AG, Amriswil (CH)

(72) Inventors: Marc Krüger, Bergisch Gladbach (DE); Günter Empl, Bergisch Gladbach (DE)

(21) Appl. No.: 18/268,367

(22) PCT Filed: Jan. 5, 2022
(86) PCT No.: PCT/EP2022/050160

§ 371 Date: Jun. 20, 2023

(30) Foreign Application Priority Data
Jan. 7, 2021 (DE) 10 2021 200 070.3

(51) Int. Cl. A47J 31/40; B67D 1/00

(52) U.S. Cl. CPC A47J 31/407; B67D 1/0078; B67D 1/0023

(57) ABSTRACT

The invention relates to a cartridge receptacle for producing a beverage by means of a cartridge which comprises a pot reservoir which is filled with a beverage substance and is closed by a sealing element, in particular a sealing film, wherein the cartridge receptacle has a connecting region for connection to the cartridge, and the cartridge receptacle with the cartridge can be inserted into Got a beverage preparation machine, wherein the cartridge receptacle has a mixing chamber, which can be brought into fluid connection to the reservoir, and a fluid supply, which opens into the mixing chamber, for introducing liquid into the mixing chamber, wherein the cartridge receptacle has a cartridge unloading device for at least partially transferring the beverage substance from the reservoir into the mixing chamber, wherein the cartridge receptacle has a beverage outlet for conducting a beverage out of the mixing chamber, in particular directly, into a beverage container, wherein the cartridge receptacle also has a gas outlet for conducting a gas, in particular carbon dioxide, released in the mixing chamber out of the cartridge receptacle.

### PRIOR ART

The invention relates to a cartridge receptacle, a cartridge system, a beverage preparation system and a method for preparing a beverage.

Such systems are known from the prior art, for example from the publications WO 2017/121 802 A1, WO 2017/121 801 A1, WO 2017/121 801 A1, WO 2017/121 799 A1, WO 2017/121 798 A1, WO 2017/121 797 A1, WO 2017/121 796 A1 and WO 2019/002 293 A1 and are used for producing beverages consisting of pre-portioned cartridges. The production of beverages using such systems is exceptionally simple for the user since a cartridge simply has to be inserted into the beverage preparation machine and a starting procedure initiated. The beverage preparation machine, also called a dispenser, then undertakes the preparation of the beverage fully automatically, i.e. in particular the food substrate or beverage substrate is mixed with a predetermined quantity of liquid, in particular cold and carbonated water, and is discharged into a drinking vessel. In this manner, in particular, mixed beverages can be produced significantly more easily, more rapidly and with less effort for the user. The user can make a selection from a plurality of different cartridges, so that different beverages can be produced as desired.

For the insertion into the beverage preparation machine, the cartridge is connected in a connecting region to a cartridge receptacle which provides an interface for coupling to the beverage preparation machine. In particular when using carbonated water, the carbonic acid, in particular in the form of carbon dioxide, can be released out of the water in the mixing chamber, in particular as a function of the volumetric flow and the temperature. The released gas will escape together with the mixed liquid out of the beverage outlet from the cartridge receptacle, which leads to disruptions in the liquid flow. The liquid jet can be interrupted, contain bubbles, escape irregularly and splash. This can lead to contamination in the immediate surroundings of the beverage preparation machine.

### DISCLOSURE OF THE INVENTION

It was, therefore, the object of the present invention to provide a cartridge receptacle and a cartridge system which do not have the aforementioned drawbacks. In particular, it is intended to be ensured that a uniform jet escapes from the cartridge receptacle.

The object is achieved by a cartridge receptacle as claimed in claim 1, by a cartridge system as claimed in claim 18, a beverage preparation system as claimed in claim 19 and a method as claimed in claim 21.

The embodiments relating to this subject of the present invention also apply equally to the other subjects of the present invention and vice versa.

The present invention relates to a cartridge receptacle for producing a beverage by means of a cartridge which comprises a reservoir which is filled with a beverage substance and which is sealed by a sealing element, in particular a sealing film. The cartridge has a cavity, the reservoir, in which a beverage substance is located. This beverage substance is preferably liquid and, in particular, a concentrate and is provided to be mixed with a liquid, in particular water, for producing the beverage and then collected in a container, in particular a glass or mug or a cup, which is preferably located on a support of a beverage preparation machine arranged below the cartridge receptacle. The beverage substance preferably comprises liquid pre-mix ingredients for soft beverages, such as caffeinated, carbonated, fruit-containing and/or sugar-containing lemonades and juices, beer (mixed) beverages or other alcoholic or non-alcoholic (mixed) beverages.

The cartridge receptacle has a connecting region for connection to the cartridge, wherein the cartridge receptacle with the cartridge can be inserted into a beverage preparation machine. The cartridge receptacle is preferably configured in the shape of a cap and has a large free opening on the side facing the cartridge. Preferably, before use the cartridge receptacle is connected positively, non-positively and/or by a material connection to the cartridge, in particular to a cartridge neck. Particularly preferably, this connection takes place in a reversible or non-reversible manner, for example via a snap-on connection and/or a screw connection. The sealing element, in particular the sealing film, preferably seals the cartridge at an open end and is particularly preferably connected by a material connection to a free edge of the cartridge, for example sealed on the edge. The sealing element preferably seals the cartridge in an airtight manner and is provided such that the beverage substance is held in the reservoir.

The cartridge receptacle has a mixing chamber which can be brought into a fluidic connection with the reservoir, and a fluid supply which opens into the mixing chamber for introducing liquid into the mixing chamber. This mixing chamber is preferably a free volume in the cartridge receptacle and particularly preferably seamlessly adjoins the connecting region, i.e. in particular is accessible via the free opening of the cartridge receptacle. The fluid supply is preferably a fluid supply opening, in particular in a lateral wall of the cartridge receptacle, so that particularly preferably the liquid is substantially introduced into the mixing chamber at right-angles to a longitudinal axis which is defined by the cartridge and the cartridge receptacle.

The cartridge receptacle has a cartridge discharge device for at least partially transferring the beverage substance from the reservoir into the mixing chamber. Moreover, the cartridge receptacle has a beverage outlet for discharging a beverage out of the mixing chamber, in particular directly, into a beverage container. The cartridge discharge device is preferably able to be activated in a targeted manner so that the beverage substance is not inadvertently transferred into the mixing chamber. Particularly preferably, the cartridge receptacle is provided such that it can be mounted on the cartridge and is then arranged with the cartridge receptacle facing downwardly in the beverage preparation machine such that the mixed beverage is transferred from the cartridge receptacle, in particular by gravity, into the beverage container.

According to the invention, it is thus provided that the cartridge receptacle also has a gas outlet for discharging out of the cartridge receptacle a gas, in particular carbon dioxide, released in the mixing chamber. The gas outlet is thus configured separately from the beverage outlet and is preferably configured such that gas released exclusively during the mixing process, i.e. in particular neither liquid nor the mixed beverage, is discharged into the environment of the cartridge receptacle. As a result, it is possible in a particularly advantageous manner that the released gas, i.e. the gas no longer dissolved in the liquid and/or in the beverage, does not negatively influence the jet of the discharged beverage and can still escape from the cartridge receptacle. At the same time, it is ensured that no liquid and/or no beverage escapes from the gas outlet. Preferably, the liquid is carbonated water and in this case the gas is, in particular, carbonic acid which is no longer dissolved, i.e. carbon dioxide.

Preferably, the cartridge receptacle is produced entirely or partially from a plastics material, in particular by an injection-molding and/or a blow molding method. According to a preferred embodiment, it is provided that the gas outlet and/or the beverage outlet is configured to be substantially channel-shaped, in particular elongated, and/or that the fluid supply is a fluid supply opening which is configured for producing a fluidic connection with a fluid line of the beverage preparation machine. Particularly preferably, the gas outlet and/or the beverage outlet extends substantially along the longitudinal axis of the cartridge when the cartridge receptacle and the cartridge are connected. Quite particularly preferably, the length of the beverage outlet is shorter than the length of the gas outlet. Since the gas outlet and the beverage outlet are arranged substantially in the same plane, in particular on the outlet side, this means in particular that the opening of the gas outlet in the mixing chamber is positioned higher than the opening of the beverage outlet, according to the usual arrangement during the beverage preparation. Thus it is advantageously ensured that only gas escapes from the gas outlet, rather than liquid.

According to a preferred embodiment, it is provided that the gas outlet is arranged substantially parallel to the beverage outlet. Particularly preferably, the gas outlet and the beverage outlet extend substantially along the longitudinal axis of the cartridge when the cartridge receptacle and the cartridge are connected. Due to the parallel design, the cartridge receptacle, in particular, can be produced more simply.

According to a preferred embodiment, it is provided that the gas outlet is arranged substantially centrally in the cartridge receptacle. As a result, it is advantageously possible that gas can flow out equally easily through the gas outlet from all regions of the mixing chamber.

According to a preferred embodiment, it is provided that an opening of the beverage outlet is larger than an opening of the gas outlet, wherein the beverage outlet has a larger cross-sectional surface than the gas outlet, in particular at least in some portions. The cartridge receptacle is preferably configured such that a substantially laminar flow is present in the mixing chamber. As a turbulent flow is substantially avoided, in particular, less gas escapes from the liquid and only a small diameter is required for the gas outlet. Due to the relatively large diameter of the beverage outlet relative to the gas outlet, this advantageously ensures a sufficiently rapid beverage preparation and at the same time an effective mixing of the liquid with the beverage substance in the meantime.

According to a preferred embodiment, it is provided that the opening of the gas outlet facing the sealing element has a smaller spacing from the sealing element than the opening of the beverage outlet facing the sealing element. As a result, it is advantageously ensured that the opening of the gas outlet is located above the liquid level in the mixing chamber so that it is ensured that only gas can escape from the gas outlet during the preparation of the beverage. Particularly preferably, it is provided that the spacing between the opening of the gas outlet facing the sealing element and the sealing element is between 0.1 mm and 1.0 mm, preferably between mm and 0.8 mm, in particular between 0.4 mm and 0.6 mm. Quite particularly preferably, it is provided that the spacing between the opening of the gas outlet facing the sealing element and the sealing element is between 5% and 50%, preferably between 10% and 40%, in particular between 20% and 30% of the spacing between the opening of the beverage outlet facing the sealing element and the sealing element. In particular, this means that the sealing element is in a resting position, i.e. without a bulging of the sealing element due to gravity and/or pressure. A person skilled in the art understands that, in particular, in the case of a sealing film as the sealing element, a sufficiently large spacing has to be present between the opening of the gas outlet and the sealing element, so that even under pressure a sufficiently large opening is present for the released gas and, on the other hand, a small spacing ensures that the gas outlet is spaced apart from the liquid flowing in the mixing chamber such that no liquid/beverage substance or no beverage escapes from the gas outlet.

According to a preferred embodiment, it is provided that the cartridge discharge device comprises a compressed air connection and a compressed air line which extends from the compressed air connection to a compressed air outlet, wherein the compressed air outlet protrudes, in particular, in the direction of the reservoir of the cartridge, wherein the compressed air connection is configured to introduce compressed air into the reservoir, wherein the cartridge discharge device is configured such that the beverage substance can be transferred by the compressed air from the reservoir into the mixing chamber. Particularly preferably, the compressed air connection is configured as an opening in a wall of the cartridge receptacle. Quite particularly preferably, the opening is arranged adjacent to the fluid supply. As a result, it is advantageously possible that the compressed air and the liquid are supplied in the same region and preferably by an element of the beverage preparation machine to the cartridge receptacle. The compressed air is preferably supplied during the preparation substantially at the same time as the liquid, so that liquid and beverage substance pass at the same time into the mixing chamber and are mixed therein. A person skilled in the art understands that, depending on the configuration, there can also be a small time offset in order to achieve a thorough mixing in the mixing chamber. The compressed air, in particular together with gravity, forces the beverage substance from the reservoir and prevents a negative pressure from being produced in the reservoir which could prevent the reservoir from being completely emptied.

According to a preferred embodiment, it is provided that the cartridge discharge device comprises a pin guide and a piercing pin which is mounted so as to be displaceable inside the pin guide, in particular in one direction, wherein the piercing pin is displaceable, in particular by an actuator element of the beverage preparation machine, between a retracted position in which the piercing pin is spaced apart from the sealing element and an extended position in which the piercing pin pierces the sealing element and protrudes into the reservoir, wherein the compressed air line is preferably integrated in the piercing pin. As a result, in a particularly advantageous manner it is possible for the cartridge to be able to be pierced in a targeted manner and thus for the beverage preparation to be able to be triggered in a targeted manner, wherein by means of the piercing pin a single element penetrates the sealing element and supplies the compressed air at the same time. Preferably, the piercing pin on its outer face has at least one, in particular elongated, channel. As a result, an outflow of beverage substance from the reservoir is made possible in a particularly simple and reliable manner.

Alternatively or additionally, the piercing pin has on its outer periphery at least one indentation and/or bulging, preferably a plurality thereof, which is/are provided as a drain for the beverage substance. The quantity and the size of the indentations and/or bulgings preferably depends on the viscosity of the substrate. The outer wall of the piercing means is thus preferably provided with at least one lateral channel for conducting the beverage substance in the direction of the mixing chamber. In particular, the beverage substance can then flow past the diaphragm in the direction of the mixing chamber by means of the lateral channel which is configured to the side on the piercing pin. Preferably, a plurality of lateral channels are configured on the piercing pin. The lateral channels are configured, in particular, in each case in the form of a groove which is open on one side. It is conceivable that the cross section of the lateral channels and/or the number of lateral channels is adapted to the viscosity of the substrate, so that the lateral channels control or limit the flow of substrate in the direction of the mixing chamber. In the case of a high viscosity, a plurality of lateral channels or lateral channels with a larger cross section are used, while in the case of a lower viscosity fewer lateral channels or lateral channels with a smaller cross section are provided. A person skilled in the art understands that this means, in particular, that a suitable cartridge receptacle is provided for each beverage substance and thus for different types of cartridge. What these embodiments have in common is that they are particularly advantageous since the piercing pin is the only movable element of the cartridge receptacle and the cartridge receptacle is thus constructed in a simple manner and can be produced in a simple manner. Preferably, a fluidic connection is present between the compressed air connection and the compressed air outlet only in the extended position. In particular, in the retracted position no compressed air can escape from the compressed air outlet. As a result, it is ensured in a particularly advantageous manner that compressed air passes out of the compressed air outlet only in the extended position, i.e. when the sealing element is pierced.

According to a preferred embodiment, it is provided that the gas outlet, the beverage outlet and/or the pin guide have a substantially circular cross section.

Alternatively, the gas outlet, the beverage outlet and/or the pin guide have an angled cross section. A circular cross section can be produced particularly simply and is particularly advantageous for a laminar flow.

Particularly preferably, the cross section is constant over the entire length of the gas outlet, the beverage outlet and/or the pin guide. Alternatively, the cross section varies over the length, for example the cross section increases in the direction of flow.

According to a preferred embodiment, it is provided that the gas outlet is arranged between the pin guide and/or the fluid supply and the beverage outlet. In order to ensure a thorough mixing of the liquid with the beverage substance, the liquid preferably has to cover a sufficiently long path between the fluid supply and the beverage outlet. Thus the region between the fluid supply and the beverage outlet is preferably provided such that no liquid flows therein. Thus the arrangement of the gas outlet in this region is particularly advantageous.

According to a preferred embodiment, it is provided that the spacing between the opening of the gas outlet facing the sealing element and the sealing element is between 10% and 80%, preferably between 30% and 60%, in particular substantially 50%, of the spacing between the opening of the pin guide facing the sealing element and the sealing element. The piercing pin preferably protrudes beyond the opening of the pin guide at least in the extended position.

According to a preferred embodiment, it is provided that the cartridge receptacle and, in particular, the beverage outlet comprises a residue outlet, wherein the cross-sectional surface of the residue outlet is preferably 2% to 30%, particularly preferably 5% to 20%, in particular 10%, of the cross-sectional surface of the beverage outlet. Particularly preferably, the residue outlet is arranged in the lowest point of the cartridge receptacle, in particular, in the orientation during the beverage preparation. As a result, it is advantageously ensured that even the last residues of liquid or beverage can be removed from the cartridge receptacle, so that no dead volume remains and the cartridge receptacle and the cartridge can be removed from the beverage preparation machine, after the beverage preparation, without liquid remaining in the cartridge receptacle escaping, in particular dripping. Thus a hygienic and clean beverage preparation is made possible.

According to a preferred embodiment, it is provided that the beverage outlet comprises a jet shaping element, wherein the jet shaping element is configured, in particular, in the shape of a cross. A person skilled in the art understands that the jet shaping element can also have a different shape and, in particular, is arranged in the direction of flow in the lower region of the beverage outlet. The jet shaping element is particularly preferably provided such that the beverage escapes from the beverage outlet in a uniform jet, in particular with a laminar flow.

According to a preferred embodiment, it is provided that the gas outlet has at least one spacing means for maintaining a minimum spacing from the sealing element, wherein the spacing means is preferably configured in the shape of a circular arc segment. Advantageously, it is ensured by the spacing means that a sufficiently large opening of the gas outlet is provided, even in the case of high pressure and a bulging of the sealing element associated therewith.

According to a preferred embodiment, it is provided that the cartridge receptacle has a flow shaping element in a region facing the fluid supply, in order to ensure a laminar flow of a liquid conducted through the fluid supply into the mixing chamber. The flow shaping element is configured, in particular, to be prow-shaped.

Advantageously, the flow-shaping element ensures that the liquid flowing into the mixing chamber is divided, in particular, without transitioning into a turbulent flow.

A further subject of the present invention is a cartridge system for producing a beverage, wherein the cartridge system can be inserted into a beverage preparation machine, having a cartridge which comprises a reservoir which is filled with a beverage substance and a cartridge receptacle according to the invention which is connected to the cartridge, wherein the cartridge receptacle and the cartridge are connected together in a connecting region, wherein the cartridge has a cartridge opening, wherein the cartridge opening in an edge region has a sealing element, in particular a sealing film, wherein the sealing element seals the reservoir in a fluid-tight manner relative to the cartridge receptacle. The cartridge system can preferably be assembled by a user. Alternatively, the cartridge system is already assembled in the factory. The connection between the cartridge and cartridge receptacle is quite preferably reversible. Alternatively, the connection is irreversible or at least not reversible in a non-destructive manner.

The embodiments relating to this subject of the present invention also apply equally to the other subjects of the present invention and vice versa.

The cartridge is preferably entirely or partially produced from a plastics material, in particular by an injection-molding and/or blow-molding method. The cartridge has a lateral wall which, for example, has a round, rectangular, square, conical or oval cross section. Generally a base which is produced, in particular, in one piece with the lateral wall is provided at one end of the lateral wall. The lateral wall, and optionally the base, span a cavity which forms the reservoir in which the beverage substance is provided, in particular in liquid form. At the other end of the lateral wall, the cartridge has an opening which is defined by a connecting region via which the cartridge is connected to the cartridge receptacle. Preferably, the connecting region comprises at least one flange. The flange protrudes from the connecting region and preferably is at an angle, in particular at right-angles, from a wall region of the connecting region. Preferably, the flange is produced from a solid material, i.e. is not hollow. In particular, the flange and/or the connecting region is configured in one piece with the lateral wall. Particularly preferably, the flange has a positioning means. The positioning means ensures that the cartridge can be connected to the cartridge receptacle only in a specific position, in particular at a specific rotational angle, in particular relative to the longitudinal axis of the cartridge. Quite particularly preferably, the positioning means is an indentation and/or bulging which in particular protrudes from the flange, in particular the periphery thereof. Preferably, the positioning means is provided in one piece with the flange. For example, the positioning means is configured as a projection which is integrally formed at one point on the periphery of the flange. Particularly preferably, the thickness of the positioning means corresponds at least substantially to the thickness of the flange.

According to a preferred embodiment, a cartridge neck is provided between the wall region and the connecting region. This cartridge neck preferably has a round cross section but, in particular, the same cross section as the lateral wall of the cartridge. The cartridge neck represents the wall region of the connecting region. The flange preferably adjoins the neck at right-angles.

According to a preferred embodiment, the sealing element, in particular the sealing film, which closes the cartridge before the use thereof, in particular hermetically, is fastened to the flange, in particular the front face thereof, in particular sealed thereto. To this end the flange, in particular the front face thereof, can have a bead, in particular an annular bead, which during sealing cooperates with the sealing tool. Preferably, the outer diameter of the diaphragm is smaller than the diameter of the flange. Preferably, a fastening means is provided in the region of the wall region of the connecting region and/or in the region of the cartridge neck. Particularly preferably, the cartridge can be connected via this fastening means to the cartridge holder. The fastening means is, in particular, a groove in which a locking means of the cartridge holder engages.

According to a preferred embodiment, it is provided that the connecting region of the cartridge cooperates, in particular sealingly, with the connecting region of the cartridge receptacle. It is particularly preferably provided that the periphery of the flange of the cartridge engages in a groove in the cartridge receptacle. This flange-groove connection, in particular, acts positively and/or non-positively, such that no relative movement occurs between the cartridge and the cartridge receptacle during the beverage preparation. This advantageously prevents the connection between the cartridge and cartridge receptacle from becoming uptight.

According to a preferred embodiment, it is provided that the cartridge and the cartridge receptacle are connected together fixedly in terms of rotation.

According to a preferred embodiment, the cartridge has a product code by which it can be identified. Once the cartridge is identified, preferably information about the beverage substance and/or the recommended preparation is available. The same applies to the container in which the beverage or food is collected. This can also comprise information and/or a product code. Particularly preferably, the cartridge and/or the cartridge receptacle has a product identification code. Preferably, the product identification code is embedded in a bar code, an RFID code, a QR code, a data matrix code, a color code, a hologram code or the like. Advantageously, therefore, an automatic reading of the product identification code is possible. Alternatively, it might be conceivable that the product identification code is also embedded in a different automatically readable computer chip. The term QR code encompasses within the meaning of the present invention, in particular, any data matrix code. In this regard, the term QR code and data matrix code are used synonymously. Alternatively or additionally, it might also be conceivable that the product identification code comprises a bar code, a dot code, a binary code, a morse code, a braille character code (braille text) or the like. The code can also be embedded in a three-dimensional structure, such as for example a relief. The product identification code comprises, in particular, the so-called product identification number, in particular a Universal Product Code (UPC), a European Article Number (EAN), a GS1 code, a Global Trade Item Number (GTIN), or the like. In this manner, no new coding system has to be introduced therefor. In particular, the product identification code operates under the GS1 Standard. The product identification code is preferably printed directly on the cartridge, adhesively bonded thereto and/or incorporated in the surface of the cartridge, for example by (laser) engraving, stamping or directly during the production of the cartridge. Alternatively, it might also be conceivable that the cartridge is at least partially enclosed by a casing, for example a sleeve, on which the product identification code is arranged. The casing can also be adhesively bonded or welded to the cartridge. The casing or the sleeve could be produced from a plastics film, a textile or paper.

Yet another subject of the present invention is a beverage preparation system comprising a beverage preparation machine and a cartridge system according to the invention, wherein the beverage preparation machine comprises a cartridge holder which is configured, in particular, to protrude forward and into which the cartridge system can be inserted, wherein the beverage preparation machine also comprises a liquid reservoir, a liquid conditioning system for conditioning a liquid from the liquid reservoir, in particular for heating, cooling and/or carbonating the liquid, an actuator element for actuating the cartridge discharge device, in particular the piercing pin, a fluid supply system which can be coupled to the cartridge system and which is provided to introduce the conditioned liquid through the fluid supply into the mixing chamber and preferably to introduce compressed air at the compressed air connection into the compressed air line, and a control device for controlling the liquid conditioning system, the fluid supply system and/or the actuator element. The beverage preparation system according to the invention is particularly advantageous since a plurality of different beverages can be rapidly prepared in a simple and hygienic manner. The cartridge holder is preferably configured to protrude forward. This means, in particular, that it protrudes from the housing of the beverage preparation machine, in particular horizontally. The cartridge system is preferably inserted from above into the cartridge holder and the beverage falls particularly preferably directly from the cartridge receptacle, i.e. in particular without contact with any element of the beverage preparation machine, into the beverage container. In particular, the cartridge holder is configured to be substantially disk-shaped. This enables not only a particularly hygienic beverage preparation but also a very high level of variability of the cartridges. The interface between the cartridge holder and the cartridge system is provided in the form of the cartridge receptacle. Since the cartridge is arranged above the cartridge holder, it can have virtually any shape. Preferably, the cartridge holder has a liquid connection which is, in particular, movably arranged. The liquid is provided by this liquid connection for producing the beverage. The liquid connection of the holder is preferably connected to the fluid supply in the cartridge receptacle, in particular in a fluid-tight manner.

The embodiments relating to this subject of the present invention also apply equally to the other subjects of the present invention and vice versa.

According to a preferred embodiment, it is provided that the liquid reservoir is releasably inserted in the beverage preparation machine. In this manner, the liquid reservoir can be removed from the beverage preparation machine, for example for filling. Particularly preferably, the liquid is water. Alternatively or additionally, the beverage preparation machine can be connected to an external liquid supply, in particular a water supply. For example, the liquid reservoir can be filled, in particular automatically, by the external water supply and/or the required liquid is removed directly from the external water supply. As a result, advantageously the ease of use of the beverage preparation machine is enhanced. Preferably, the beverage preparation machine has at least one pump, in particular a diaphragm pump, for conveying the liquid. Particularly preferably, the beverage preparation machine also has at least one flow rate measuring device for detecting and controlling the liquid volumetric flow, in particular a flow sensor, for example an ultrasonic flow sensor or a magnetic-inductive flow sensor.

According to a preferred embodiment, it is provided that the liquid conditioning system has at least one temperature control device for controlling the temperature of the liquid. Particularly preferably, the temperature control device is a cooling unit for cooling the liquid. Alternatively, the beverage preparation machine is coupled to an external temperature control device. Advantageously, therefore, cold beverages can be produced even when the cartridge itself is not cooled and, for example, is at room temperature. The cooling unit preferably comprises a compressor cooling unit, an absorber cooling unit or a thermoelectric cooler. According to a further preferred embodiment of the present invention, it is provided that the liquid conditioning system comprises at least one carbonator, in order to add carbonic acid to the liquid. Particularly preferably, it is provided that the beverage preparation machine has the carbonator and also a receptacle for at least one carbon dioxide reservoir, in particular a carbon dioxide cartridge. Advantageously, carbonated (soft) beverages can also be produced with the system. Alternatively, the beverage preparation machine can be coupled to an external carbon dioxide source.

According to a preferred embodiment, it is provided that the actuator element has at least one projection which positively and/or non-positively engages in a lower end of the piercing pin and when activated displaces this piercing pin in the direction of the cartridge inside the pin guide such that the piercing pin pierces the sealing element. Particularly preferably, the beverage preparation machine comprises a drive for the actuator element. Quite particularly preferably, the drive is arranged inside a housing of the beverage preparation machine and thus, in particular, is not arranged in the cartridge holder and is connected by a suitable mechanism to the actuator element in the cartridge holder.

According to a preferred embodiment, it is provided that the fluid supply system has a pump, in particular a diaphragm pump, for conveying the liquid. Particularly preferably, the fluid supply system also comprises at least one flow rate measuring device for detecting and controlling the liquid volumetric flow, in particular a flow sensor, for example an ultrasonic flow sensor or a magnetic-inductive flow sensor. Quite particularly preferably, the fluid supply system comprises a movable coupling element which has, in particular, an integrated compressed air line and/or an integrated liquid line and is provided to be movable such that a fluid-tight coupling is made with the fluid supply and/or the compressed air connection of the cartridge receptacle when the cartridge system is inserted in the cartridge holder. Alternatively, the coupling element is provided to be movable and is configured such that a fluid-tight coupling is made with the fluid supply and/or the compressed air connection of the cartridge receptacle when the cartridge system is inserted in the cartridge holder.

According to a preferred embodiment, it is provided that the beverage preparation machine and/or the fluid supply system comprises a compressed air source. Alternatively, the beverage preparation machine and/or the fluid supply system can be coupled to an external compressed air source. In particular, the beverage preparation machine is provided such that compressed air is applied to the compressed air connection of the cartridge receptacle as soon as a coupling of the coupling element to the compressed air connection is made or as soon as the actuator element activates the piercing means. In this manner, it is advantageously ensured that when the sealing element is pierced the beverage substance is transferred without delay into the mixing chamber and, in particular, no beverage substance enters the compressed air line and thus leads to a contamination of the beverage preparation machine with the beverage substance.

According to a preferred embodiment, it is provided that the beverage preparation machine also has a product code detector for detecting a product code of the cartridge and/or the cartridge receptacle. Particularly preferably, the product code detector is arranged above and/or behind the cartridge holder, in particular in a housing of the beverage preparation machine above the cartridge holder. The product code detector comprises, in particular, an optical sensor, such as for example a CCD camera, which automatically reads the product code, in particular the product identification code, when the cartridge system is inserted in the beverage preparation machine. Alternatively, the product code detector comprises a transmitting and receiving antenna for automatically reading, for example, an RFID code.

According to a preferred embodiment, it is provided that the beverage preparation machine has a locking means in order to lock the cartridge system reversibly in the cartridge holder, wherein the locking means can be actuated by a user. Particularly preferably, the locking means is connected to the control device such that a beverage preparation process is possible only when the cartridge system is successfully locked in the cartridge holder. In this manner, a possible malfunction and damage to the cartridge system and/or the beverage preparation machine is prevented and a contamination by liquid and/or beverage substance avoided. Quite particularly preferably, the locking means comprises a fastening flange which positively and/or non-positively encompasses the cartridge receptacle during or after insertion in the holder. The fastening flange preferably also comprises a triggering mechanism which is configured such that an actuation of the triggering mechanism leads to the cartridge receptacle being gripped by the fastening flange and/or to the fastening flange being displaced, such that a relative movement between the cartridge receptacle and the actuator element in contact with the piercing means is generated, whereby the piercing means is transferred from the retracted position into the extended position. The triggering mechanism comprises, for example, a hand lever for the manual actuation thereof, wherein the hand lever is preferably configured to be rotatable about an axis of rotation substantially parallel to the longitudinal axis of the cartridge. Moreover, the triggering mechanism preferably comprises a transmission gear which translates a rotational movement of the hand lever about the axis of rotation which is parallel to the longitudinal axis into a translational movement substantially parallel to the longitudinal axis. After the cartridge system has been inserted into the holder, the hand lever is actuated by the user, whereby the cartridge system is firmly gripped and displaced linearly against the triggering element. By the anti-twist device and the translation of the rotational movement into the linear translational movement, it is ensured that the orientation of the cartridge remains constant relative to the cartridge holder. As a result, a possible identification of a (product identification) code is advantageously simplified.

A further subject of the present invention is a method for preparing a beverage with a beverage preparation system according to the invention, characterized by the following steps:
inserting a cartridge system composed of a cartridge and a cartridge receptacle into the cartridge holder,
producing a fluidic connection between the fluid supply system and the cartridge receptacle,
activating the actuator element for actuating the cartridge discharge device, in particular by transferring the piercing pin from the retracted position into the extended position, whereby a perforation of the sealing means is brought about,
transferring the beverage substance from the reservoir of the cartridge into the mixing chamber of the cartridge receptacle, in particular by feeding compressed air into the cartridge through the compressed air connection,
introducing a liquid into the mixing chamber of the cartridge receptacle through the fluid supply and
discharging through the beverage outlet the beverage produced in the mixing chamber by mixing the beverage substance with the liquid,
discharging through the gas outlet gas, in particular carbon dioxide, released during the mixing.

The embodiments relating to this subject of the present invention also apply equally to the other subjects of the present invention and vice versa.

Advantageously, the method according to the invention enables a beverage preparation or a beverage production which is exceptionally flexible and in a hygienic and rapid manner, since the only condition is that the beverage substance and the liquid are able to be mixed. It is ensured by the gas outlet, which is in particular separate, that released gas does not disrupt the escaping volumetric flow of the beverage and thus undesired effects such as a partially interrupted jet, splashes, bubbles and the like are avoided. A person skilled in the art understands that the quantity of released gas depends on a plurality of parameters such as temperature, pressure, volumetric flow, viscosity of the beverage substance and/or liquid and degree of carbonation. The gas outlet, however, is preferably provided such that any reasonably anticipated quantity of gas can be safely discharged.

According to a preferred embodiment, it is provided that the transfer of the beverage substance into the mixing chamber and the introduction of the liquid into the mixing chamber substantially take place at the same time.

As a result, it is ensured that a uniform beverage is produced and transferred into the beverage container. In particular, it is generally not desirable if the liquid and the beverage substance flow at least partially separately out of the cartridge receptacle.

According to a preferred embodiment, it is provided that before being introduced into the mixing chamber the liquid is temperature-controlled in the beverage preparation machine, in particular cooled, and carbonated. As a result, advantageously the preparation of a cooled carbonated soft beverage is made possible.

According to a preferred embodiment, it is provided that the activation of the actuator element comprises a displacement of the piercing pin along the pin guide. It is important here that a relative movement takes place between the actuator element of the cartridge holder or the beverage preparation machine, wherein this can comprise a movement of the cartridge system and/or the actuator element.

According to a preferred embodiment, it is provided that a locking step follows the insertion of the cartridge system into the cartridge holder, in which a locking means is automatically or manually actuated. Particularly preferably, it is provided that during or after inserting the cartridge system in the holder a fastening flange of the cartridge holder is operated by a triggering mechanism which can be actuated manually or by motor such that the cartridge receptacle is positively and/or non-positively gripped by the fastening flange, and/or that the fastening flange is displaced such that a relative movement is generated between the cartridge receptacle and the actuator element which is operatively connected to the cartridge discharge device, whereby the piercing means is transferred from the retracted position into the extended position.

According to a preferred embodiment, it is provided that the production of a fluidic connection between the fluid supply system and the cartridge receptacle comprises a relative movement between a movable coupling element and the cartridge receptacle, such that a fluid-tight connection is generated. Particularly preferably, at the same time a fluidic connection is produced between a machine-side liquid line and the fluid supply of the cartridge receptacle and a fluidic connection between a machine-side compressed air line and the compressed air connection of the cartridge receptacle.

According to a preferred embodiment, it is provided that the beverage substance is transferred from the reservoir of the cartridge into the mixing chamber of the cartridge receptacle such that compressed air is introduced through the cartridge discharge device into the reservoir of the cartridge, whereby the beverage substance, in particular, flows outside the piercing pin through the sealing element into the mixing chamber. The compressed air can optionally only compensate for the escaping volume of the beverage substance in order to prevent a negative pressure in the cartridge, or the compressed air can actively displace the beverage substance out of the reservoir, so that the transfer from the reservoir into the mixing chamber takes place at higher pressure, in particular relative to a pressure in the reservoir for the beverage preparation and/or relative to an ambient pressure.

According to a preferred embodiment, it is provided that the liquid is introduced in the mixing chamber such that a substantially, in particular exclusively, laminar flow is present. A person skilled in the art understands that this depends on different parameters, such as for example the temperature, the degree of carbonation, the rate of volumetric flow, the cross section of the volumetric flow, wherein particularly preferably the control device adapts the machine parameters to the beverage preparation machine, in particular by the fluid conditioning system and/or fluid supply system, such that a laminar flow is present. As a result, advantageously a greater release of gas is avoided.

According to a preferred embodiment of the present invention, it is provided that before, during or after the insertion of the cartridge system in the cartridge holder and/or the feeding of compressed air into the cartridge and/or the feeding of liquid into the mixing chamber and/or the actuation of the cartridge discharge device, at least one product code, in particular a product identification code, of the cartridge and/or the cartridge receptacle is read by the product code detector. The read product identification code is preferably evaluated by an evaluation unit, wherein the feeding of the compressed air and/or the liquid and/or the actuation of the cartridge discharge device only takes place when the product identification code has been verified by the evaluation unit. In this manner, it is ensured that the beverage preparation system can be set in operation only with cartridge systems which are known, or certified or authorized for the beverage preparation machine, so that damage to the beverage preparation system or a risk of injury to the user due to inadvertent use of incorrect cartridge systems, which for example cannot withstand the pressure of the compressed air and/or the liquid, are avoided. It is also conceivable that the properties of the supplied diluting agent and, in particular, the time profile of the volumetric flow, total volume, pressure, conveying pauses, temperature and/or carbonation of the supplied compressed air are controlled as a function of the product identification code. Alternatively or additionally, the properties of the supplied compressed air and, in particular, the time profile of the volumetric flow, total volume, conveying pauses and/or pressure of the supplied compressed air are controlled as a function of the product identification code. Preferably, the ratio between the volumetric flow of the liquid and the volumetric flow of the compressed air is controlled as a function of the product identification code. In particular, all parameters of the beverage substance or the beverage preparation and/or parameter ranges of the beverage preparation process which can be set by the beverage preparation machine are embedded in the product identification code, so that the beverage preparation machine obtains from the cartridge all of the information which is required or which is at least helpful for producing the respective beverage. It is also conceivable that this information is stored in an internal memory of the beverage preparation machine and retrieved by means of the product identification code for the respective cartridge system and used for controlling the beverage production process as soon as the presence of this cartridge system in the cartridge holder is detected.

### DESCRIPTION OF THE FIGURES

The invention is explained hereinafter with reference to FIGS. 1 to 6. These explanations are merely by way of example and do not limit the general inventive idea. The explanations apply to the cartridge according to the invention, the cartridge system according to the invention, the beverage preparation system according to the invention and equally to the method according to the invention.

FIGS. 1 and 2 show schematic cross sections of a cartridge receptacle according to exemplary embodiments of the present invention.

FIGS. 3 and 4 show different views of a cartridge receptacle according to exemplary embodiments of the present invention.

FIGS. 5 and 6 show schematic cross sections of a cartridge system, a beverage preparation system and a method according to an exemplary embodiment of the present invention.

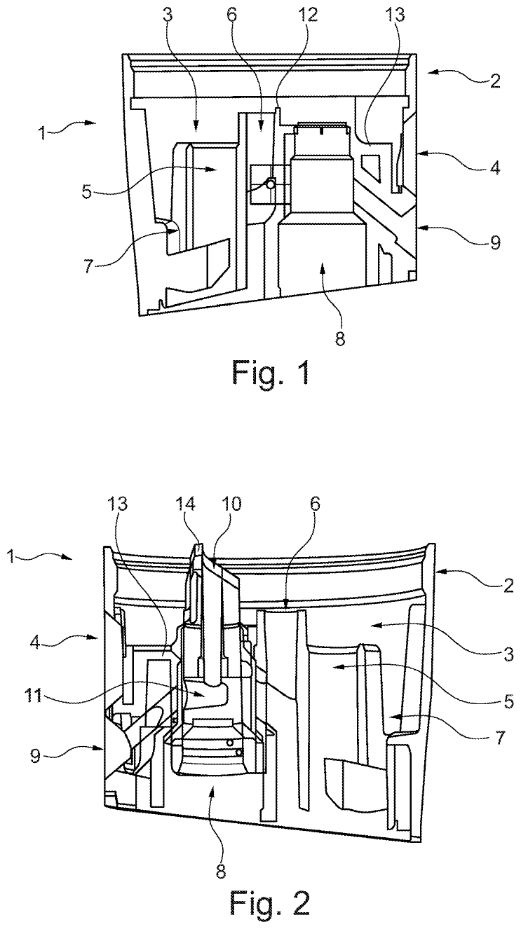

A schematic cross section of a cartridge receptacle 1 according to an exemplary embodiment of the present invention is shown in FIG. 1. Such a cartridge receptacle 1 is configured, in particular, in the manner of a cap and is mounted on a cartridge 16 in order to form a cartridge system.

The cartridge 16, which is not shown here for the sake of clarity, comprises a lateral wall and a base connected to the lateral wall, preferably configured in one piece therewith. On the end opposing the base the cartridge has an opening which is preferably surrounded by a cartridge neck which particularly preferably has a smaller diameter than the lateral wall. On the open end, the cartridge 16 preferably has at least one flange 18, in particular oriented at right-angles to the longitudinal axis of the cartridge 16. This flange 18 is provided, on the one hand, to create a non-positive and/or positive connection with a connecting region 2 of the cartridge receptacle 1. On the other hand, a sealing element is preferably fastened to the flange 18.

According to the embodiments explained herein, the sealing element is a sealing film 19 which is sealed, for example, to the flange 18 and thereby seals the cavity in the cartridge 16, in particular in a fluid-tight, i.e. liquid-tight and air-tight, manner. The cavity serves as a reservoir 17 for a preferably liquid beverage substance. A person skilled in the art understands that a beverage substance can also be instead, in particular, a liquid food substance, such as for example baby food, porridge, soup or medicinal products such as high-calorie food. It is significant that the (beverage) substance is provided to be mixed with a liquid, in particular water.

The cartridge 16 and, in particular, the lateral wall can have substantially any shape, for example a round or angled cross section, and dimensions, in particular length and diameter, in a range which is as a wide as possible. Only the cartridge neck has to be configured such that it can be connected in a connecting region to the connecting region 2 of the cartridge receptacle. It is a particular advantage of the beverage preparation system according to the invention that the cartridge holder 24 of the beverage preparation machine is preferably configured to protrude forward. This means, in particular, that the cartridge holder 24 protrudes from a housing of the beverage preparation machine, in particular substantially horizontally, and is configured to be substantially disk-shaped. The cartridge system consisting of the cartridge 16 and the cartridge receptacle 1 is inserted into the cartridge holder upside down, i.e. such that the opening of the cartridge 16 faces downwardly and the cartridge receptacle 1 is the lowest element of the cartridge system, and preferably reversibly locked therein. This means that the cartridge 16 freely protrudes upwardly from the cartridge holder 24 and thus is free in terms of shape.

The cartridge receptacle 1 has in the connecting region 2 an opening which directly adjoins the sealing element, here the sealing film 19. On the opposing end the cartridge receptacle 1 according to the invention has at least two openings. The one opening is a beverage outlet via which the finished mixed beverage can exit and is preferably transferred directly into a beverage container, such as a cup, a mug or a glass. The beverage outlet 5 is preferably configured in a channel-like manner, i.e. it comprises lateral walls and a longitudinal extent. The length of the beverage outlet 5 is selected, in particular, such that a directed and uniform beverage jet is generated. Particularly preferably, to this end the beverage outlet also comprises a jet shaping element 15, for example a cross, which is arranged in the lower region and is configured to shape the jet as desired.

A fluid supply 4 is provided in a lateral wall of the cartridge receptacle 1, the fluid supply being configured here as a hole, in particular with a conical border. This fluid supply 4 cooperates in the beverage preparation machine with a coupling element 20 through which a liquid, in particular cooled and/or carbonated water, is introduced through the fluid supply 4 into the cartridge receptacle 1.

The free volume in the cartridge receptacle 1 serves as a mixing chamber 3 in which the beverage substance is mixed with the inflowing liquid, and thus forms the desired beverage before it escapes through the beverage outlet 5.

As can be derived from the illustration, an upper opening of the beverage outlet 5 is located above a lower region of the mixing chamber 3 so that a length which is sufficient for a jet shaping is achieved. So that the beverage produced in the mixing chamber 3 can still be discharged out of the cartridge receptacle 1 without residues and, in particular, so that it is possible to avoid a continuous dripping when removing the cartridge system from the beverage preparation machine and a remaining unusable dead volume, the cartridge receptacle 1 can also have a residue outlet 7 which is provided, in particular, at the lowest point of the mixing chamber (in the orientation as is present in the arrangement mounted in the beverage preparation machine). Particularly preferably, the residue outlet 7 is provided adjacent to the beverage outlet 5 and/or is at least partially part of the beverage outlet 5. Here, for example, the beverage outlet 5 is provided such that it has a substantially circular cross section, wherein a small region of the cross section is configured in a region of the periphery of the residue outlet 7. In particular, the upper inlet surface of the residue outlet 7 is arranged lower than the upper inlet surface of the beverage outlet 5. In the present case, this also results in the length and the cross-sectional surface of the residue outlet 7 being significantly smaller than the length and the cross-sectional surface of the beverage outlet 5 since the residue outlet 7 is merely provided for discharging a relatively small residual volume.

In order to transfer the beverage substance from the reservoir 17 into the mixing chamber 3, the cartridge receptacle 1 has a cartridge discharge device. Below the fluid supply 4 the cartridge receptacle 1 has a compressed air connection 9 which also has a conical border here, in order to cooperate with a compressed air supply of the beverage preparation machine, so that compressed air can be introduced into the cartridge receptacle 1. Preferably, the machine-side coupling element 20 comprises both a compressed air line 21 and a liquid line 22 so that the coupling element 20 can be coupled with both openings to the fluid supply 4 and the compressed air connection 9, in particular at the same time. The compressed air is conducted in the direction of a pin guide 9 from the compressed air connection 9. This pin guide is configured here as an opening which positively receives a piercing pin 14, not shown here, such that the piercing pin is longitudinally displaceable between a retracted position and an extended position.

The compressed air connection 9, the pin guide 8 and the piercing pin 14 form part of the cartridge discharge device.

The piercing pin 14 is provided such that it cooperates with an actuator element 23 of the beverage preparation machine, in particular the cartridge holder 24, so that the piercing pin 14 can be transferred from its retracted position into the extended position. In the extended position, the piercing pin 14 perforates the sealing film 19 so that the beverage substance can flow through the sealing film 19 into the mixing chamber 3, in particular via at least one groove-shaped channel arranged on the outer periphery of the piercing pin 14. Since a negative pressure would or could otherwise be produced in the reservoir 17 of the cartridge 16 by the arrangement of the cartridge system and the configuration of the cartridge receptacle 1, the piercing pin 14 has an internal compressed air line 11 which opens into the tip of the piercing pin 14 in a compressed air outlet 10, wherein the piercing pin 14 and, in particular, the compressed air line 11 are configured such that the compressed air line 11 is only fluidically connected to the compressed air connection 9 in the extended position. As a result, it is ensured that compressed air is not inadvertently introduced into the mixing chamber 3. The compressed air is introduced into the reservoir 17 during the preparation and replaces the volume released therein by the outflow of the beverage substance into the mixing chamber 3. Preferably, the compressed air supply is controlled by a control device of the beverage preparation machine such that the compressed air additionally assists the transfer of the beverage substance into the mixing chamber, i.e. in particular a small excess pressure is built up in the cartridge 16.

Alternatively or additionally, it is also conceivable that the beverage preparation machine controls the compressed air supply, such that toward the end of the beverage preparation a residual volume of the beverage substance, the liquid and/or the beverage is driven out of the cartridge system via the residue outlet 7.

Moreover, the cartridge receptacle 1 also has a flow shaping element 13 which faces the fluid supply and which is preferably configured to be prow-shaped. The flow shaping element 13 is provided to divide, and in particular to distribute evenly, the liquid flow entering the mixing chamber 3. In particular, it should be avoided that a turbulent flow occurs since this impedes a uniform mixing of the liquids and since, in particular in the case of carbonated water, in a turbulent flow an increased outgassing of the carbonic acid into the environment occurs, in particular as carbon dioxide. When maintaining a substantially laminar flow this release of gas is minimized. A person skilled in the art understands that this outgassing is dependent, amongst other things, on the temperature, pressure and flow rate.

Generally, however, a certain volume of gas, in particular carbon dioxide, is released in the mixing chamber. This gas could escape, for example, through the beverage outlet 5 into the environment and disrupt the beverage jet. Thus, for example, it can lead to an intermittent jet, to splashes or bubbles. This is not desirable. Thus the cartridge receptacle 1 according to the invention also has a gas outlet 6 which is configured, in particular, separately from the beverage outlet 5. “Separately” means, in particular, that liquid and/or gas from the mixing chamber 3 cannot pass downstream from the beverage outlet 5 into the gas outlet 6 and vice versa, and thus no holes or fluidic connections are present between the two outlets which are preferably configured in a channel-like manner. So that it is ensured that in turn no liquid, i.e. neither the introduced liquid nor the beverage substance or the finished beverage, escapes via the gas outlet 6 but that the beverage is discharged primarily via the beverage outlet 5 and secondarily via the smaller residue outlet 7, an upper inlet surface of the gas outlet 6, as illustrated here, is arranged higher than the upper inlet surface of the beverage outlet 5.

The gas outlet 6 is provided here substantially centrally in the cartridge receptacle 1 but it can also be arranged, for example, in an edge region. The arrangement shown here is advantageous, however, since it is desired in any case that the liquid and the beverage substance covers a path which is as long as possible between the fluid supply 4 and the beverage outlet 6 for the purpose of thorough mixing, and thus the central region between the pin guide 8 and the beverage outlet 5 is advantageously available.

However, depending on the conditions and parameters of the beverage preparation, it can lead to the sealing film 19 being not entirely horizontally oriented, due to gravity and/or the pressure prevailing in the reservoir, but being bulged in the direction of the mixing chamber. A person skilled in the art understands that, in particular, in the central arrangement of the gas outlet 6 proposed here, the upper inlet opening of the gas outlet 6 is located in the region of the maximum bulging of the sealing film 19. So that a sufficiently large opening is still available, via which the released gas can escape, the gas outlet 6 on its upper periphery has at least one spacer means 12, in this case, for example, at least one circular arc segment-shaped projection which optionally comes into contact with the bulged sealing film and thus ensures a minimum spacing and, as a result, a minimum free opening cross section between the inlet opening of the gas outlet and the sealing film 19. According to the exemplary embodiment shown here, the spacing between the upper end of the gas outlet 6 and an imaginary horizontal sealing film 19 is at least 0.40 mm, in particular at least 0.45 or 0.50 mm.

A further schematic cross section of a cartridge receptacle 1 is shown in FIG. 2. Here the cartridge receptacle 1 substantially corresponds to the embodiment explained in connection with FIG. 1 so that reference is made to the relevant embodiments.

Here the cartridge receptacle 1 is shown rotated by 180°, i.e. the fluid supply 4 and the compressed air connection 9 are shown to the left in the drawing. Moreover, the piercing pin 14 is also arranged in the pin guide 8, wherein the piercing pin 14 is shown here by way of example in the extended position. As visible in the drawing, a fluidic connection is produced therein between the compressed air connection 9 and the compressed air outlet 10 through the compressed air line 11. In the position shown, if the piercing pin 14, i.e. in a mounted cartridge system, had pierced the sealing film 19, the beverage substance would be transferred from the reservoir 17 into the mixing chamber, assisted by the compressed air introduced into the cartridge 16. A channel is also indicated on the piercing pin 14, in the upper left region, the beverage substance advantageously being able to flow thereby into the mixing chamber. This channel is particularly preferably open outwardly, i.e. configured in the shape of a groove.

It is also shown in FIG. 2 that the piercing pin 14 preferably has a tip and an obliquely arranged surface which assist a perforation of the sealing film 19. The compressed air outlet 10 is preferably provided in the aforementioned surface and, in particular, centrally in the piercing pin 14.

On its lower end in the drawing, the piercing pin 14 has a region which is designed here as a recess in which an actuator element 23 of the beverage preparation machine engages in order to transfer the piercing pin 14 from the retracted position into the extended position. This region is preferably configured at least in some portions to taper upwardly, i.e. in the direction of the tip of the piercing pin 14, in order to permit a simple centering of the actuating element 23, whereby a canting of the piercing pin 14 in the pin guide 8 and resulting therefrom a possible damage to the cartridge system and/or the beverage preparation machine is avoided.

In the present case, the lower end region of the cartridge receptacle 1 is provided obliquely but this is primarily an aesthetic decision, for example a substantially horizontally arranged end region might also be possible which is oriented, in particular, parallel to the opening plane defined by the connecting region and, in particular, the upper peripheral edge.

Here the gas outlet 6 and the beverage outlet 5 have a substantially circular cross section, wherein a small region is removed from the beverage outlet 5, this region being taken up by the residue outlet 7. A person skilled in the art understands, however, that in principle also other cross sections, for example oval-shaped or polygonal cross sections, are possible.

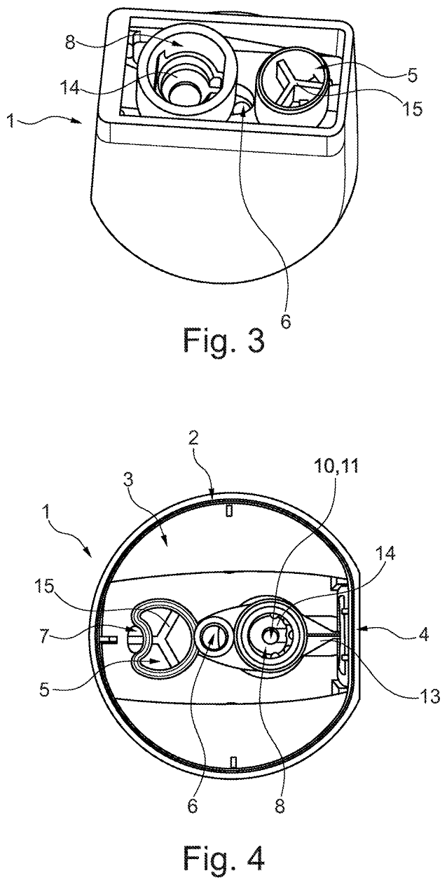

A perspective view of the cartridge receptacle 1 according to the embodiment shown in FIG. 2 is shown in FIG. 3. The above embodiments thus also apply to the embodiment shown in FIG. 3.

In particular, the shaping of the cartridge receptacle 1 can be seen here merely by way of example. This cartridge receptacle has at its upper end, which corresponds to the lower end according to the views of FIGS. 1 and 2, a wall-like rectangular edge region, the beverage outlet the gas outlet 6 and the pin guide 8 being arranged therein.

Apart from this region, the cartridge receptacle 1 substantially has a domed shape, i.e. in principle it is configured to be rounded on its end opposing the opening.

In FIG. 3, in particular, it can be identified that the gas outlet 6 has a smaller opening cross section compared with the beverage outlet 5, in particular also compared with the pin guide.

A jet shaping element 15, which is configured here to be rib-shaped and cross shaped, is also shown in FIG. 3 in the beverage outlet 5. The length of the beverage outlet 5, the cross section thereof and the jet shaping element 15 together serve to shape and to direct the escaping beverage jet.

The gas outlet 6, in comparison with the beverage outlet has a smaller spacing from the sealing film 19, so that only gas can escape from the gas outlet 6. The gas can flow out of the gas outlet 6 in any manner, however, such that the gas outlet 6 does not have to have any such jet shaping elements. A certain minimum length of the gas outlet 6 is not significant, so that this gas outlet, as shown here, has a simple and in particular a lower opening (according to the orientation shown here) in comparison with the pin guide 8 and/or the beverage outlet 5.

In FIG. 4 only a plan view of the cartridge receptacle 1 is shown from the side of the connecting region 2. This embodiment also substantially corresponds to the embodiments already explained above, so that the relevant embodiments are also applicable here. Here, in particular, it can be identified that the cartridge receptacle 1 has a substantially circular cross section with a flattened portion in the region of the fluid supply 4 and the compressed air connection 9 in order to permit a simpler coupling to the beverage preparation machine. In particular, the region of the cartridge holder 24 receiving the cartridge receptacle 1 is preferably configured such that it receives the cartridge receptacle 1 positively and/or non-positively. Due to the flattened region a preferred orientation is also advantageously ensured thereby, so that a reliable coupling to the beverage preparation machine takes place.

The prow shape of the flow shaping element 13 is clearly identifiable here, the flow shaping element in the present case being integrally formed on the pin guide 8, wherein the flow shaping element 13, the pin guide 8, the connecting region 2, the gas outlet 6, the beverage outlet 5 and/or residue outlet 7 are preferably formed in one piece.

Preferably, the cartridge 16 and/or the cartridge receptacle are produced from a plastics material, in particular by means of an injection-molding or a blow-molding method.

Particularly preferably, the piercing pin 14 is produced separately from the same materials and/or by the same method and then inserted in the cartridge receptacle 1. Alternatively, the piercing pin 14 is produced at the same time with the cartridge receptacle 1.

The configuration of the residue outlet 7 can also be identified in FIG. 4. Here the residue outlet 7 has a substantially oval cross section and a circular segment-shaped region is removed from the substantially circular cross section of the beverage outlet 5, the residue outlet 7 being provided therein. In other words, apart from a partition wall, the beverage outlet 5 and the residue outlet 7 together form a substantially circular cross section. It is only important that the residue outlet 7 is arranged in the lowest region of the mixing chamber 3. As shown here, this residue outlet can transition into the beverage outlet 5 downstream thereof.

The gas outlet 6 and the pin guide 8 are also connected by way of example by a rounded portion in order to improve the flow conditions in the mixing chamber 3.

Finally, it is possible to identify ribs protruding inwardly at a plurality of points along the periphery of the connecting region 2, i.e. in the direction of the mixing chamber 3, the ribs serving as spacers for the cartridge 16 so that a correct mounting of the cartridge system is ensured, also optionally on the part of the user.

Finally, it can be identified from the view in FIG. 4 that, in particular, the residue outlet 7, the beverage outlet 5, the gas outlet 6, the pin guide 8 and the fluid supply 4 and the compressed air connection 9 are located substantially on an imaginary axis, which runs here in the image from left to right, and the mixing chamber 3 is largely provided on both sides of this axis.

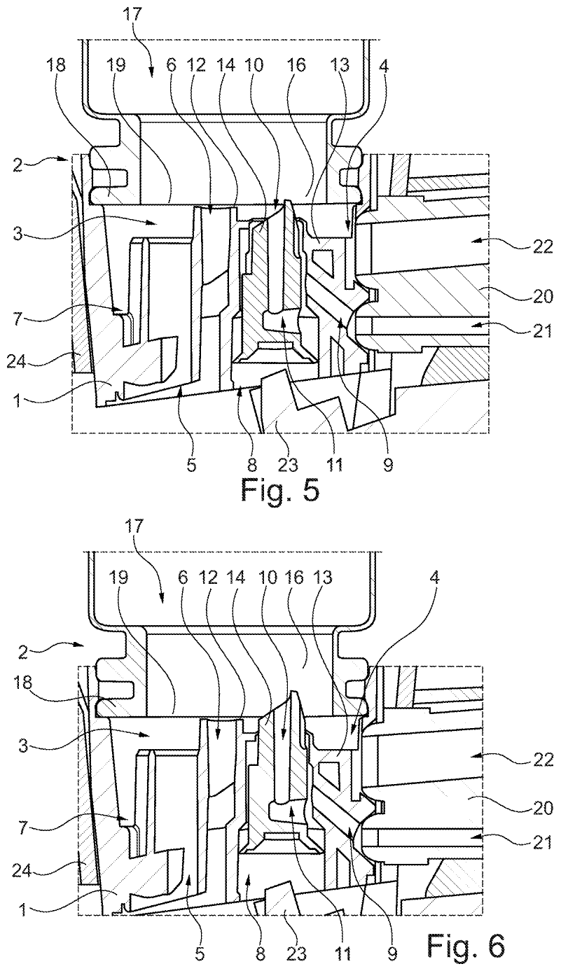

In FIGS. 5 and 6 schematic cross sections of a cartridge system inserted in a cartridge holder 24 of a beverage preparation machine of a beverage preparation system are shown according to an exemplary embodiment of the present invention. The views differ in that in FIG. 5 the piercing pin 14 has just pierced the sealing film 19 with its tip, while in FIG. 6 a later position is shown. Both views show positions of the piercing pin 14 between the retracted position and the fully extended position.

The embodiments shown in FIGS. 5 and 6 of the cartridge receptacle 1 also substantially correspond to the embodiments already explained above so that the relevant embodiments are also applicable here.

In the present case, for reasons of clarity, the cartridge 16 and the beverage preparation machine are only indicated. The cartridge 16 can be identified on the upper edge of the drawing and comprises at least one flange 18 by which the cartridge 16 is connected positively and/or non-positively via the connecting region 2 to the cartridge receptacle 1. In order to ensure a secure connection, in particular a rotationally fixed connection, the cartridge 16 can also have, for example, two vertically spaced-apart peripheral flanges. The sealing film 19 is sealed to the flange, which thus represents the outermost element of the cartridge 16.

In FIG. 5 the tip of the piercing pin 14 has just pierced the sealing film 19. The compressed air connection 9 is not yet fluidically connected to the compressed air outlet 10 and preferably substantially no beverage substance is able to pass from the reservoir 17 into the mixing chamber 3.

In order to clarify the elements of the cartridge receptacle 1 and their respective functions, in the present case the actuator element 23 of the beverage preparation machine is illustrated spaced apart from the piercing pin 14, but a person skilled in the art understands that the piercing pin 14 is preferably transferred from the retracted position into the extended position by a permanent contact between an actuator element receptacle of the piercing pin 14 and the actuator element 23, in particular by a permanent application of force, here upwardly in the vertical direction.

It can also be identified in FIG. 5 that a coupling element 20 of the beverage preparation machine is already in contact with the fluid supply 4 and the compressed air connection 9, wherein in particular guide surfaces of the coupling element 20 cooperate with the conical surfaces of the fluid supply 4 and the compressed air connection 9 in order to ensure a fluid-tight and secure coupling. The coupling element 20 has both an internal liquid line 22 and an internal compressed air line 21, which in each case are connected indirectly to a liquid reservoir of the beverage preparation machine or an external liquid supply or a compressed air source of the beverage preparation machine or an external compressed air supply. “Indirectly” means in this case that, in particular, further components are present between the liquid reservoir and the liquid line 22, such as a liquid conditioning system which is provided, for example, to carbonate and/or too cool the liquid, in particular water, and to introduce the liquid under pressure into the liquid line 22. The carbonated and cooled water flows through the fluid supply 4 into the mixing chamber 3, wherein the flow shaping element 13 ensures that a substantially laminar flow is maintained.

In FIG. 6 a piercing pin 14 has penetrated sufficiently far forward through the sealing film 19 that the compressed air outlet 10 is arranged inside the reservoir 17 and the, in particular groove-shaped, channel provided on the outer face of the piercing pin 14 provides a path for the beverage substance from the reservoir 17 into the mixing chamber 3. The compressed air line 11 of the piercing pin 14 already partially overlaps the compressed air connection 9 so that a partial fluidic connection is present and compressed air can pass from the machine-side compressed air line 21 into the reservoir 17 and contributes to the transfer of the beverage substance into the mixing chamber 3, where a mixing with the optionally carbonated and/or cooled water takes place before it is dispensed via the beverage outlet 5 into a beverage container arranged therebelow. A person skilled in the art understands that, depending on the beverage, the beverage preparation machine can be operated with different parameters and/or the cartridge receptacle 1 is correspondingly configured. Thus, for example, the temperature and/or the degree of carbonation of the water can be controlled. The dilution ratio can also be controlled, in particular, by a user.

To this end, firstly the volumetric flow of the liquid, for example the water, can be controlled. The volumetric flow of the beverage substance can also be controlled. This can take place firstly via the volumetric flow of the compressed air, but secondly for example also via the number or the size of channels of the piercing pin 14 and/or the diameter of the piercing pin 14 passing through the sealing film 19.

According to the invention, gas released during the preparation, in particular carbon dioxide in the case of carbonated water, is discharged via the gas outlet 6 from the cartridge receptacle 1 into the environment.

### LIST OF REFERENCE SIGNS

1 Cartridge receptacle
2 Connecting region
3 Mixing chamber
4 Fluid supply
5 Beverage outlet
6 Gas outlet
7 Residue outlet
8 Pin guide
9 Compressed air connection
10 Compressed air outlet
11 Compressed air line
12 Spacing means
13 Flow shaping element
14 Piercing pin
15 Jet shaping element
16 Cartridge
17 Reservoir
18 Flange
19 Sealing film
20 Coupling element
21 Compressed air line (machine-side)
22 Liquid line (machine-side)
23 Actuator element
24 Cartridge holder

1. A cartridge receptacle for producing a beverage by means of a cartridge which comprises a reservoir which is filled with a beverage substance and which is sealed by a sealing element, wherein the cartridge receptacle comprises:
a) a connecting region for connection to the cartridge, and wherein the cartridge receptacle with the cartridge can be inserted into a beverage preparation machine;
b) a mixing chamber which can be brought into a fluidic connection with the reservoir;
c) a fluid supply which opens into the mixing chamber for introducing liquid into the mixing chamber,
d) a cartridge discharge device for at least partially transferring the beverage substance from the reservoir into the mixing chamber;
e) a beverage outlet for discharging a beverage out of the mixing chamber into a beverage container;
f) a gas outlet for discharging a gas released in the mixing chamber out of the cartridge receptacle, and wherein an upper inlet surface of the gas outlet is arranged higher than an upper inlet surface of the beverage outlet.

2. The cartridge receptacle as claimed in claim 1, wherein the gas outlet and/or the beverage outlet is configured to be substantially channel-shaped, and/or in that the fluid supply is a fluid supply opening which is configured for producing a fluidic connection with a fluid line of the beverage preparation machine.

3. The cartridge receptacle as claimed in claim 1, wherein the gas outlet is arranged substantially parallel to the beverage outlet.

4. The cartridge receptacle as claimed in claim 1, the gas outlet arranged substantially centrally in the cartridge receptacle.

5. The cartridge receptacle as claimed in claim 1, wherein an opening of the beverage outlet is larger than an opening of the gas outlet, and wherein the beverage outlet has a larger cross-sectional surface than the gas outlet at least in some portions.

6. The cartridge system as claimed in claim 18, an opening of the gas outlet facing the sealing element has a smaller spacing from the sealing element than an opening of the beverage outlet facing the sealing element.

7. The cartridge system as claimed in claim 18, wherein that a spacing between an opening of the gas outlet facing the sealing element and the sealing element is between 0.1 mm and 1.0 mm.

8. The cartridge system as claimed in claim 18, a spacing between an opening of the gas outlet facing the sealing element and the sealing element is between 5% and 50% of a spacing between the opening of the beverage outlet facing the sealing element and the sealing element.

9. The cartridge receptacle as claimed in claim 1, wherein the cartridge discharge device comprises a compressed air connection and a compressed air line which extends from the compressed air connection to a compressed air outlet, wherein the compressed air outlet protrudesin a direction of the reservoir of the cartridge, wherein the compressed air connection is configured to introduce compressed air into the reservoir, wherein the cartridge discharge device is configured such that the beverage substance can be transferred by the compressed air from the reservoir into the mixing chamber.

10. The cartridge receptacle as claimed in claim 1, wherein the cartridge discharge device comprises a pin guide and a piercing pin which is mounted so as to be displaceable inside the pin guide, wherein the piercing pin is displaceable by an actuator element the beverage preparation machine, between a retracted position in which the piercing pin is spaced apart from the sealing element and an extended position in which the piercing pin pierces the sealing element and protrudes into the reservoir, wherein a compressed air line is integrated in the piercing pin.

11. The cartridge receptacle as claimed in claim 1, wherein the gas outlet, the beverage outlet and/or a pin guide have a substantially circular cross section.

12. The cartridge receptacle as claimed in claim 1, wherein the gas outlet is arranged between a pin guide and/or the fluid supply and the beverage outlet.

13. (canceled)

14. The cartridge receptacle as claimed in claim 1, wherein the cartridge receptacle comprises a residue outlet, wherein a cross-sectional surface of the residue outlet is 2% to 30% of cross a sectional surface of the beverage outlet, and wherein the residue outlet is arranged in a lowest point of the cartridge receptacle in orientation during the beverage preparation.

15. The cartridge receptacle as claimed in claim 1, wherein the beverage outlet comprises a jet shaping element, wherein the jet shaping element is configured in a shape of a cross.

16. The cartridge receptacle as claimed in claim 1, wherein the gas outlet has at least one spacing means for maintaining a minimum spacing from the sealing element, wherein the spacing means is configured in a shape of a circular arc segment.

17. The cartridge receptacle as claimed in claim 1, wherein the cartridge receptacle has a flow shaping element in a region facing the fluid supply in order to ensure a laminar flow of a liquid conducted through the fluid supply into the mixing chamber.

18. A cartridge system for producing a beverage, wherein the cartridge system can be inserted into a beverage preparation machine, comprising:
a cartridge which comprises a reservoir which is filled with a beverage substance, and
the cartridge receptacle as claimed in claim 1, which is connected to the cartridge;
wherein the cartridge receptacle and the cartridge are connected together in a connecting region;
wherein the cartridge has a cartridge opening;
wherein the cartridge opening in an edge region has a sealing element,
wherein the sealing element seals the reservoir in a fluid-tight manner relative to the cartridge receptacle.

19. A beverage preparation system comprising
a) a beverage preparation machine; and
b) the cartridge system as claimed in claim 18;
wherein the beverage preparation machine comprises;
i. a cartridge holder, which is configured to protrude forward and into which the cartridge system can be inserted
ii. a liquid reservoir;
iii. a liquid conditioning system for conditioning a liquid from the liquid reservoir, for heating, cooling, and/or carbonating the liquid;
iv. an actuator element for actuating the cartridge discharge device;
v. a fluid supply system, which can be coupled to the cartridge system and which is provided to introduce the conditioned liquid through the fluid supply into the mixing chamber and to introduce compressed air at a compressed air connection into a compressed air line; and
vi. a control device for controlling the liquid conditioning system, the fluid supply system, and/or the actuator element.

20. The beverage preparation system as claimed in claim 19, wherein the beverage preparation machine has a locking means in order to lock the cartridge system reversibly in the cartridge holder, wherein the locking means can be actuated by a user.

21. A method for preparing a beverage with the beverage preparation system as claimed in claim 19, the method comprising:
inserting a cartridge system composed of a cartridge and a cartridge receptacle into the cartridge holder;
producing a fluidic connection between the fluid supply system and the cartridge receptacle;
activating the actuator element for actuating the cartridge discharge device by transferring a piercing pin from a retracted position into an extended position, whereby a perforation of a sealing means is brought about;
transferring the beverage substance from the reservoir of the cartridge into the mixing chamber of the cartridge receptacle by feeding compressed air into the cartridge through the compressed air connection;
introducing a liquid into the mixing chamber of the cartridge receptacle through the fluid supply;
discharging through the beverage outlet the beverage produced in the mixing chamber by mixing the beverage substance with the liquid; and
discharging through the gas outlet released during the mixing.
